(19) United States
(12) Patent Application Publication
(10) Pub. No.: US 2020/0262204 A1
(43) Pub. Date: Aug. 20, 2020

(54) INKJET RECORDING APPARATUS

(71) Applicant: KYOCERA Document Solutions Inc., Osaka (JP)

(72) Inventor: Sho HARABE, Osaka-shi (JP)

(73) Assignee: KYOCERA Document Solutions Inc., Osaka (JP)

(21) Appl. No.: 16/791,383

(22) Filed: Feb. 14, 2020

(30) Foreign Application Priority Data
Feb. 18, 2019 (JP) 2019-026677

(51) Int. Cl. B41J 2/165; B41J 2/175

(52) U.S. Cl. CPC B41J 2/16505; B41J 2002/16594; B41J 2/17596

(57) ABSTRACT

An inkjet recording apparatus 1 includes a recording head 21, an ink supply mechanism 3, and a motor. The recording head 21 includes an ink discharge surface 22 and discharges an ink from the ink discharge surface 22 onto a recording medium. The ink supply mechanism 3 supplies the ink to the recording head 21. The motor is rotatable back and forth. The ink supply mechanism 3 includes a pump. The pump exerts a positive pressure or a negative pressure on the ink according to a rotation direction of the motor. The controller performs a cleaning operation for cleaning the ink discharge surface. The cleaning operation includes a purge operation and a follow operation.

### INCORPORATION BY REFERENCE

The present application claims priority under 35 U.S.C. § 119 to Japanese Patent Application No. 2019-26677, filed on Feb. 18, 2019. The contents of this application are incorporated herein by reference in their entirety.

### BACKGROUND

The present disclosure relates to an inkjet recording apparatus.

An inkjet recording apparatus includes a recording head. The recording head includes an ink discharge surface. An ink is discharged from the ink discharge surface toward a recording medium to form an image on the recording medium.

When forming an image, a part of the ink discharged from the ink discharge surface remains on the ink discharge surface. The ink contains a volatile component. As a result of the volatile component evaporating, the ink thickens to be residual ink.

The residual ink causes nozzle clogging for example. Therefore, it has been studied to prevent evaporation of volatile components from the ink and to remove residual ink from the ink discharge surface.

For example, an inkjet recording apparatus exerts a suction force on a nozzle in a state where the recording head is closed with a cap. The inkjet recording apparatus purges ink from the ink discharge surface by supplying a pressurized ink to the nozzle while the suction force is exerted.

An inkjet recording apparatus according to an aspect of the present disclosure includes a recording head, an ink supply mechanism, and a motor. The recording head includes an ink discharge surface, and discharges an ink from the ink discharge surface onto a recording medium. The ink supply mechanism supplies the ink to the recording head. The motor is configured to rotate back and forth. The ink supply mechanism includes a pump. The pump exerts a positive pressure or a negative pressure on the ink according to a rotation direction of the motor. The controller controls the motor so as to perform a cleaning operation for cleaning the ink discharge surface. The cleaning operation includes a purge operation in which the pump exerts a positive pressure on the ink, and a follow operation in which the pump exerts a negative pressure on the ink after completion of the purge operation.

### BRIEF DESCRIPTION OF THE DRAWINGS

FIG. 1 is a perspective view of an inkjet recording apparatus in an embodiment of the present disclosure.

FIG. 2 is a diagram illustrating a configuration of the inkjet recording apparatus in the embodiment of the present disclosure.

FIG. 3 is a diagram illustrating a configuration of the inkjet recording apparatus in the embodiment of the present disclosure.

FIG. 4 is a perspective view illustrating a configuration of a recording section and a vicinity thereof in the embodiment of the present disclosure.

FIG. 5 is a perspective view illustrating the configuration of a recording section and a vicinity thereof in the embodiment of the present disclosure.

FIG. 6 is a perspective view illustrating an ink supply mechanism and a recording head in the embodiment of the present disclosure.

FIG. 7 is a diagram illustrating a part of the inkjet recording apparatus in the embodiment of the present disclosure.

FIG. 8 is a partially enlarged view of FIG. 7.

FIG. 9 is diagram illustrating a configuration of the recording head and the ink supply mechanism in the embodiment of the present disclosure.

FIG. 10A is a diagram illustrating a configuration of the recording head and the ink supply mechanism in a positive pressure mode.

FIG. 10B is a diagram illustrating a configuration of the recording head and the ink supply mechanism in a negative pressure mode.

FIG. 11 is a block diagram illustrating a configuration of the inkjet recording apparatus in the embodiment of the present disclosure.

FIG. 12 is a flowchart illustrating a process executed by a controller in the embodiment of the present disclosure.

### DETAILED DESCRIPTION

The following describes an embodiment of an inkjet recording apparatus 1 according to the present disclosure with reference to drawings. Elements which are the same or equivalent are labeled with the same reference signs in the drawings and description thereof is not repeated. In the present embodiment, an up-down direction, a left-right direction, and a front-back direction that are orthogonal to one another are shown in the drawings. The up-down direction is parallel to a vertical plane, and the left-right direction and the front-back direction are parallel to a horizontal plane.

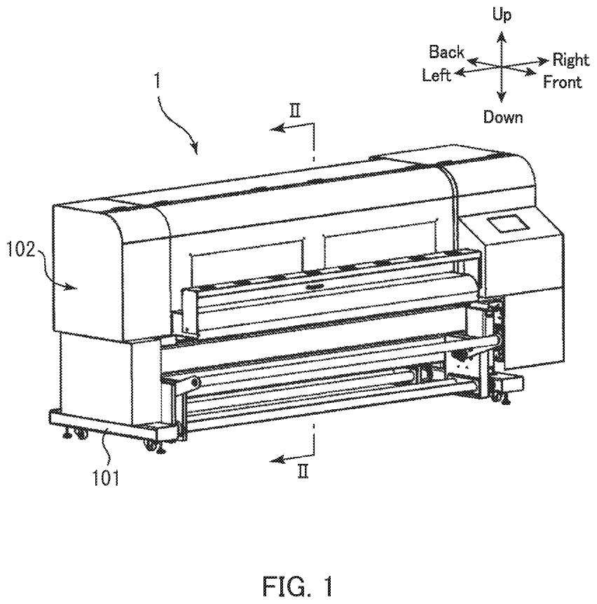

First, the inkjet recording apparatus 1 in the present embodiment will be described with reference to FIGS. 1 to 3. FIG. 1 is a perspective view of the inkjet recording apparatus 1 in the present embodiment. The inkjet recording apparatus 1 in the present embodiment is a textile printing apparatus configured to perform inkjet textile printing. A textile printing apparatus forms a specific image on a cloth. Note that a cloth is an example of the recording medium.

As illustrated in FIG. 1, the inkjet recording apparatus 1 includes an apparatus frame 101 and an exterior cover 102. The exterior cover 102 covers the apparatus frame 101.

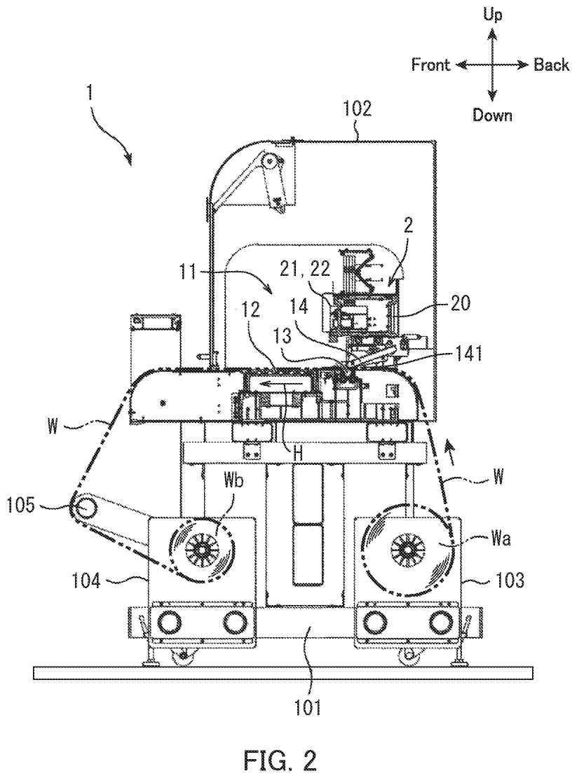

FIG. 2 is a diagram illustrating a configuration of the inkjet recording apparatus 1 in the present embodiment. Specifically, FIG. 2 is a cross-sectional view taken on the line II-II shown in FIG. 1 and looking in the direction of the arrows.

As illustrated in FIG. 2, the inkjet recording apparatus 1 includes a recording section 2, an unwinding section 103, a conveying mechanism 11, a winding section 104, and a tension roller 105.

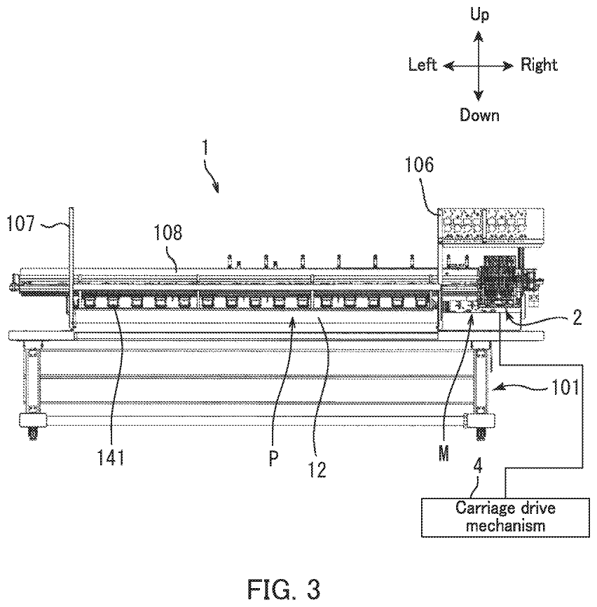

The recording section 2 discharges an ink to form a specific image on a cloth. The recording section 2 includes a carriage 20 and a recording head 21. The carriage 20 will be described later with reference to FIG. 3. In the present embodiment, the recording section 2 includes two recording heads 21. The two recording heads 21 are mounted on the carriage 20. In the following description of the embodiment, the two recording heads 21 will be simply referred to as a “recording head 21” in a situation where there is no need to distinguish therebetween.

The recording head 21 discharges an ink. Specifically, the recording head 21 includes an ink discharge surface 22. The ink is discharged from the ink discharge surface 22.

A feed roll Wa is attached to the unwinding section 103. The unwinding section 103 continuously unwinds a long cloth W wound around the feed roll Wa. The feed roll Wa is a wound body in which the cloth W before image formation is wound around a core rod.

The conveying mechanism 11 conveys the cloth W unwound from the unwinding section 103 in a conveyance direction H. The conveying mechanism 11 includes a conveyance driving section, a platen 12, a conveying roller 13, and a pinch roller unit 14. The conveyance driving section includes for example a motor.

The platen 12 supports the cloth W unwound from the unwinding section 103. The conveying roller 13 is rotated by a driving force transmitted from the conveyance driving section. The conveying roller 13 is a long roller extending in the left-right direction. The pinch roller unit 14 includes a plurality of pinch rollers 141. The pinch rollers 141 are arranged at equal intervals in the left-right direction (see FIG. 3). Pinch rollers 141 are disposed in a manner to face the conveying roller 13 to hold the cloth W sandwiched between the conveying roller 13 and the pinch rollers. The cloth W is sandwiched between the conveying roller 13 and the pinch rollers 141 and conveyed while being supported by the platen 12.

The winding section 104 winds up the cloth W conveyed by the conveying mechanism 11. The cloth W wound up by the winding section 104 is referred to below as “wind-up roll Wb”. The wind-up roll Wb is a wound body in which the cloth W after image formation is wound around a core rod.

The tension roller 105 exerts tension on the cloth W so that the cloth W does not sag. The tension roller 105 is located between the conveying mechanism 11 and the winding section 104.

FIG. 3 is a diagram illustrating a configuration of the inkjet recording apparatus 1 in the present embodiment. Specifically, FIG. 3 is a front view of the inkjet recording apparatus 1 from which the exterior cover 102 illustrated in FIG. 1 has been removed. Note that the inkjet recording apparatus 1 illustrated in FIG. 3 is not in a state where image formation is being performed.

As illustrated in FIG. 3, the apparatus frame 101 includes a first frame 106, a second frame 107, and a carriage guide 108. The first frame 106 and the second frame 107 face each other in the left-right direction. The first frame 106 is disposed in a right side of the inkjet recording apparatus 1. The second frame 107 is disposed in a left side of the inkjet recording apparatus 1. The carriage guide 108 extends in the left-right direction. The carriage guide 108 passes through the first frame 106 and the second frame 107. The carriage guide 108 supports the carriage 20 described above with reference to FIG. 2 in a state where the carriage 20 is movable. In other words, the carriage 20 and the recording head 21 are movable along the carriage guide 108.

The inkjet recording apparatus 1 further includes a carriage drive mechanism 4. The carriage drive mechanism 4 includes for example a motor. The carriage 20 moves along the carriage guide 108 when the carriage drive mechanism 4 is driven.

The platen 12 described above with reference to FIG. 2 is disposed between the first frame 106 and the second frame 107. Accordingly, the cloth W is conveyed between the first frame 106 and the second frame 107 by the conveying mechanism 11 described with reference to FIG. 2. In other words, the inkjet recording apparatus 1 can form an image on the cloth W only in an area between the first frame 106 and the second frame 107. The area between the first frame 106 and the second frame 107 is referred to below as an “image forming area P”. The inkjet recording apparatus 1 further includes a maintenance area M. In the inkjet recording apparatus 1, maintenance is performed in the maintenance area M. The maintenance includes for example a cleaning operation and a purge operation.

The maintenance area M is located on a right side of the first frame 106 in the inkjet recording apparatus 1. In other words, the maintenance area M is an area on an immediate right side of the image forming area P.

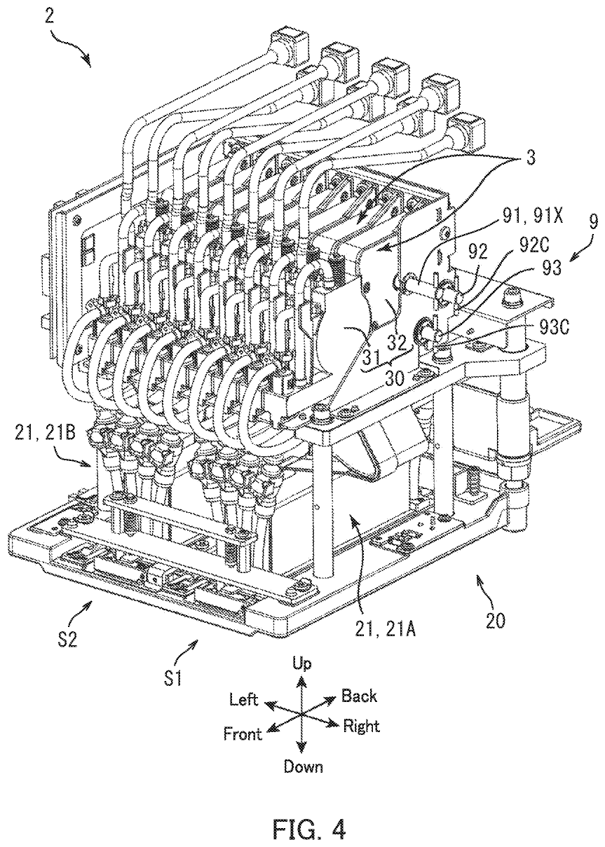

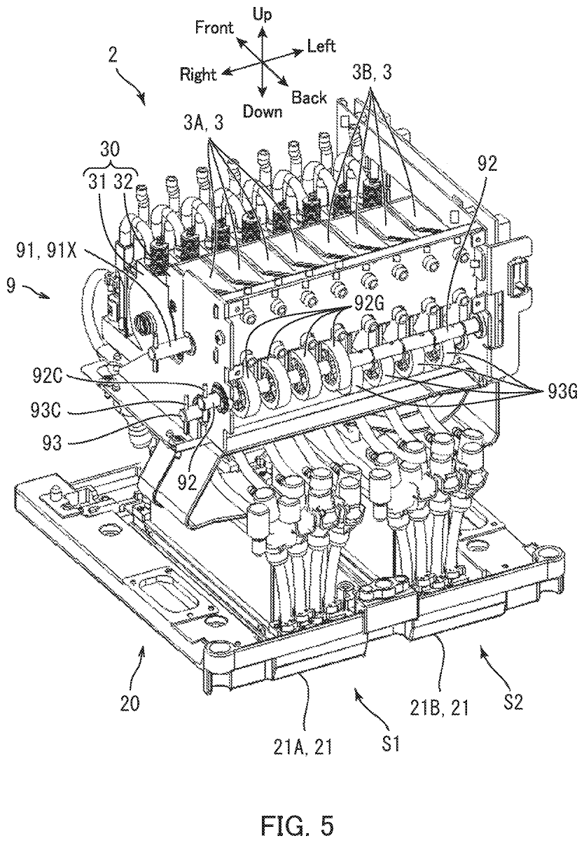

Next, a configuration of the recording section 2 and a vicinity thereof in the present embodiment will be described with reference to FIGS. 4 and 5. FIGS. 4 and 5 are perspective views illustrating the configuration of the recording section 2 and the vicinity thereof in the present embodiment. Specifically, FIG. 4 is a diagram of the recording section 2 and the vicinity thereof as viewed diagonally from a forward right side. FIG. 5 is a diagram of the recording section 2 and the vicinity thereof as viewed diagonally from a backward right side. In FIG. 5, a frame of the carriage 20 is partly omitted.

As illustrated in FIGS. 4 and 5, the carriage 20 includes a first mounting section S1 and a second mounting section S2. The first mounting section S1 is disposed in a right side of the carriage 20. The second mounting section S2 is disposed in a left side of the carriage 20.

On the first mounting section S1, one recording head 21 of the two recording heads 21 is mounted. On the second mounting section S2, the other recording head 21 is mounted. The recording head 21 mounted on the first mounting section S1 may be referred to below as a “first recording head 21A”. Similarly, the recording head 21 mounted on the second mounting section S2 may be referred to below as a “second recording head 21B”.

As illustrated in FIGS. 4 and 5, the inkjet recording apparatus 1 further includes an ink supply mechanism 3 in addition to the recording head 21. The ink supply mechanism 3 is mounted on the carriage 20 together with the recording head 21.

The ink supply mechanism 3 is disposed above the recording head 21. As a result of disposing the ink supply mechanism 3 above the recording head 21, the ink supply mechanism 3 can be disposed so as to overlap the recording head 2 in the front-back direction and the left-right direction, and the size of the carriage 20 in the front-rear direction and the left-right direction can be reduced.

The ink supply mechanism 3 supplies an ink to the recording head 21. The ink supply mechanism 3 exerts a positive pressure or a negative pressure on the ink. The number of the ink supply mechanisms 3 corresponds to the number of the recording heads 21. In the present embodiment, the inkjet recording apparatus 1 includes eight ink supply mechanisms 3. Specifically, of the eight ink supply mechanisms 3, four ink supply mechanisms 3 are mounted on the first mounting section S1 and the remaining four ink supply mechanisms 3 are mounted on the second mounting section S2. The four ink supply mechanisms 3 mounted on the first mounting section S1 may be referred to below as a “first supply unit 3A”. The four ink supply mechanisms 3 mounted on the second mounting section S2 may be referred to below as a “second supply unit 3B”. In the following description of the embodiment, the eight ink supply mechanisms 3 will be simply referred to as an “ink supply mechanism 3” in a situation where there is no need to distinguish therebetween.

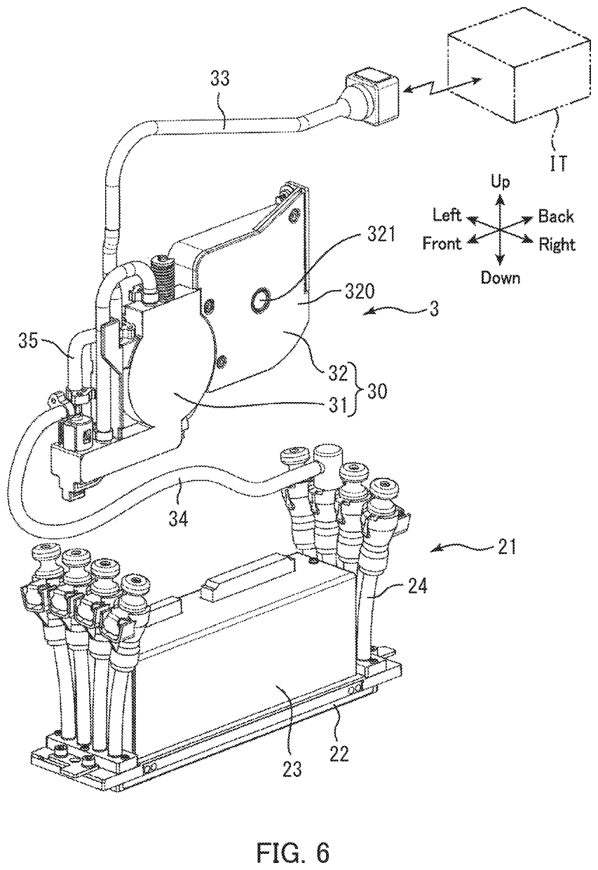

The ink supply mechanism 3 includes a main body 30, a tank section 31, and a pump section 32. The tank section 31 and the pump section 32 are disposed in the main body 30. The tank section 31 and the pump section 32 will be described below with reference to FIG. 6.

Next, a configuration of the recording head 21 and the ink supply mechanism 3 will be described with reference to FIG. 6. FIG. 6 is a perspective view illustrating a configuration of the ink supply mechanism 3 and the recording head 21 in the present embodiment. Specifically, one of the eight ink supply mechanisms 3 and one of the two recording heads 21 are illustrated.

As illustrated in FIG. 6, the recording head 21 includes a control unit 23 and end tubes 24 in addition to the ink discharge surface 22. The control unit 23 controls the ink discharge operation from the ink discharge surface 22.

The ink supply mechanism 3 further includes an upstream pipe 33, a downstream pipe 34, and a bypass pipe 35 in addition to the main body 30, the tank section 31, and the pump section 32.

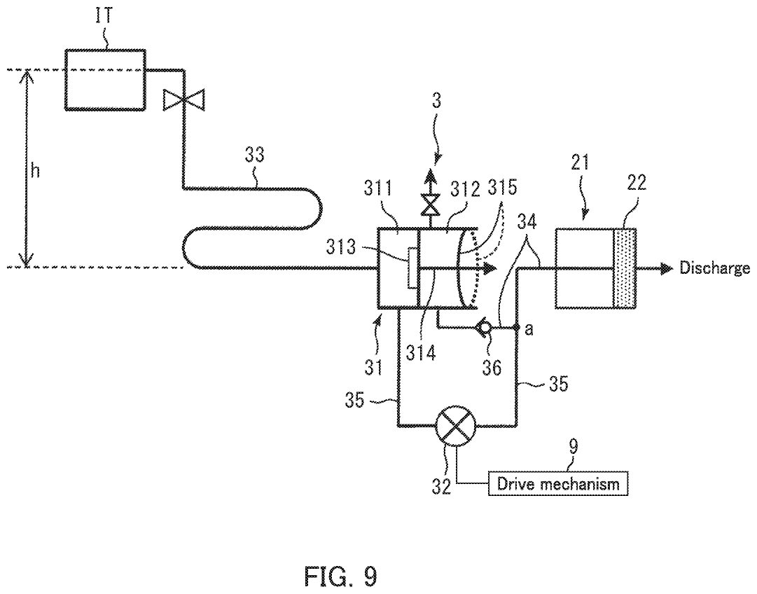

The tank section 31 stores the ink. The tank section 31 will be described later with reference to FIG. 9.

The pump section 32 exerts a positive pressure or a negative pressure on the ink. The pump section 32 includes a housing 320 and a camshaft insertion hole 321.

The camshaft insertion hole 321 is formed in the housing 320. In the present embodiment, the pump section 32 includes a tubing pump. The tubing pump is disposed inside the housing 320.

The tubing pump includes an eccentric cam and a squeezed tube. The eccentric cam includes a shaft hole. The shaft hole faces the camshaft insertion hole 321.

The tank section 31 and an ink tank IT communicate with each other through the upstream pipe 33. The tank section 31 and the recording head 21 communicate with each other through the downstream pipe 34. Specifically, the downstream pipe 34 is connected to an end tube 24 included in the recording head 21. The bypass pipe 35 sends the ink to the downstream pipe 34.

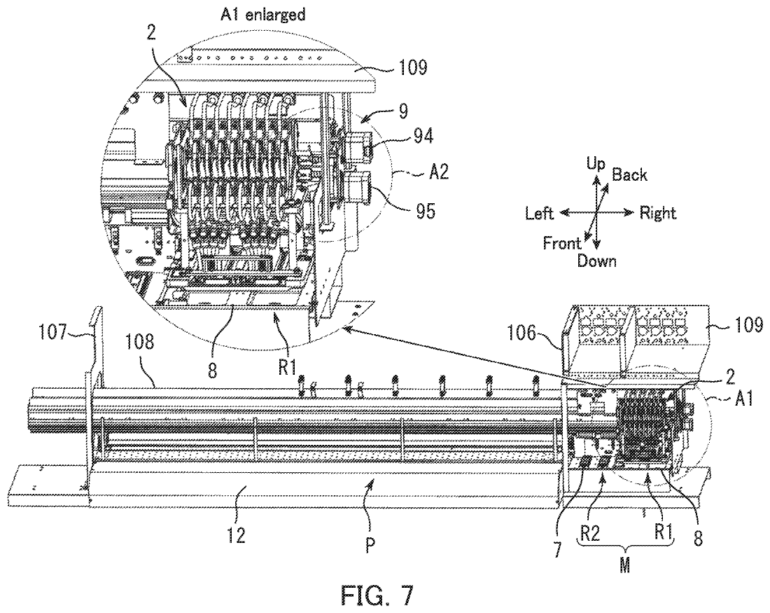

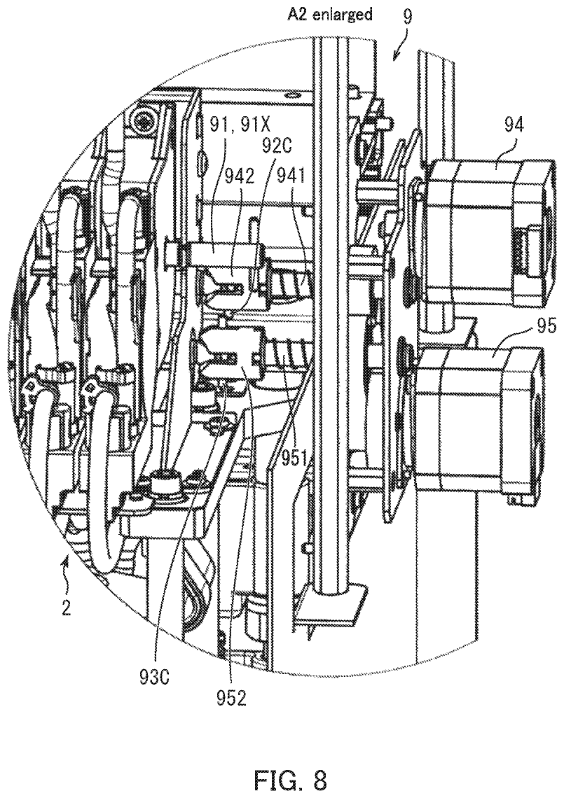

Next, a drive mechanism 9 in the present embodiment will be described with reference to FIGS. 4, 5, 7, and 8. FIG. 7 is a diagram illustrating a part of the inkjet recording apparatus 1 in the present embodiment. Specifically, a part of the inkjet recording apparatus 1 and an enlarged view of the part are shown. The partial enlarged view shown in FIG. 7 shows the maintenance area M in an enlarged manner. Note that the apparatus frame 101 is omitted in the inkjet recording apparatus 1 illustrated in FIG. 7. FIG. 8 is a partially enlarged view of FIG. 7. Specifically, FIG. 8 is an enlarged view of A2 in FIG. 7.

The inkjet recording apparatus 1 further includes a drive mechanism 9 as illustrated in FIGS. 4, 5, 7, and 8.

The drive mechanism 9 includes a cam driving section 91, a first drive shaft 92, and a second drive shaft 93 as illustrated in FIGS. 4 and 5. The drive mechanism 9 further includes a first drive motor 94 and a second drive motor 95 as illustrated in FIGS. 7 and 8. The first drive motor 94 and the second drive motor 95 are rotatable back and forth. The first drive motor 94 and the second drive motor 95 are each for example a stepping motor.

The first drive motor 94 includes a first output shaft 941 and a coupling 942 as illustrated in FIG. 8. The first output shaft 941 is coupled to an output shaft of the first drive motor 94. The coupling 942 is attached to the tip of the first output shaft 941.

The second drive motor 95 includes a second output shaft 951 and a coupling 952. The second output shaft 951 is coupled to an output shaft of the second drive motor 95. The coupling 952 is attached to the tip of the second output shaft 951.

The cam driving section 91 transmits a driving force to the pump section 32. The cam driving section 91 includes a camshaft 91X and a gear. The camshaft 91X is rotatable. The camshaft 91X extends in the left-right directions. The camshaft 91X is inserted into the camshaft insertion hole 321 described with reference to FIG. 6. The eccentric cam of the pump section 32 is attached to the camshaft 91X. Therefore, the eccentric cam rotates when the camshaft 91X rotates. The rotation direction of the eccentric cam changes according to the rotation direction of the camshaft 91X. As a result of the rotation direction of the eccentric cam changing, the direction of pressure in the tubing pump (squeezed tube) changes. The rotational speed of the eccentric cam changes according to the rotational speed of the camshaft 91X. As a result of the rotational speed of the eccentric cam changing, the magnitude of pressure in the tubing pump (squeezed tube) changes.

The first drive shaft 92 and the second drive shaft 93 each extend in the left-right directions. In other words, the camshaft 91X, the first drive shaft 92, and the second drive shaft 93 are parallel to one another. The first drive shaft 92 and the second drive shaft 93 are each rotatable. The first drive shaft 92 and the second drive shaft 93 are disposed around the circumference of the camshaft 91X. Specifically, the first drive shaft 92 is located behind and below the camshaft 91X. The second drive shaft 93 is located behind the camshaft 91X and in front of the first drive shaft 92, and below the camshaft 91X and the first drive shaft 92.

The first drive shaft 92 rotates as a result of a driving force transmitted from the first drive motor 94. Specifically, the first drive shaft 92 includes a first coupling pin 92C. The first coupling pin 92C is disposed at the right end of the first drive shaft 92. The first coupling pin 92C is coupled to the coupling 942 of the first drive motor 94 (see FIG. 8). As a result, the driving force from the first drive motor 94 is transmitted to the first drive shaft 92, and the first drive shaft 92 rotates. The first drive shaft 92 rotates, thereby transmitting the driving force from the first drive motor 94 to the cam driving section 91.

Specifically, the drive mechanism 9 includes four first transmission gears 92G. The four first transmission gears 92G are attached to the first drive shaft 92. The first drive shaft 92 rotates, thereby rotating the four first transmission gears 92G. The four first transmission gears 92G are arranged at specific intervals in the right half of the first drive shaft 92. Specifically, the four first transmission gears 92G are each disposed at a position facing one of the pump sections 32 of the four ink supply mechanisms 3 constituting the first supply unit 3A such that each first transmission gear engages (meshes) with an idle gear disposed in each pump section 32. Therefore, as a result of the four first transmission gears 92G each rotating, the camshaft 91X is caused to rotate via the idle gears. As a result, the eccentric cam in the tubing pump rotates. That is, the driving force from the first drive motor 94 is transmitted to each pump section 32 of the first supply unit 3A.

The second drive shaft 93 rotates as a result of a driving force transmitted from the second drive motor 95. Specifically, the second drive shaft 93 includes a second coupling pin 93C. The second coupling pin 93C is disposed at the right end of the second drive shaft 93. The second coupling pin 93C is coupled to a coupling 952 of the second drive motor 95 (see FIG. 8). As a result, the driving force from the second drive motor 95 is transmitted to the second drive shaft 93, and the second drive shaft 93 rotates. The second drive shaft 93 rotates, thereby transmitting the driving force from the second drive motor 95 to the cam driving section 91.

Specifically, the drive mechanism 9 includes four second transmission gears 93G. The four second transmission gears 93G are attached to the second drive shaft 93. Therefore, the four second transmission gears 93G rotate when the second drive shaft 93 rotates. The four second transmission gears 93G are arranged at specific intervals in the left half of the second drive shaft 93. Specifically, the four second transmission gears 93G are each disposed at a position facing one of the pump sections 32 of the four ink supply mechanisms 3 constituting the second supply unit 3B such that each second transmission gear engages (meshes) with an idle gear disposed in each pump section 32. Therefore, as a result of the four second transmission gears 93G each rotating, the camshaft 91X is caused to rotate via the idle gears. As a result, the eccentric cam in the tubing pump rotates. That is, the driving force from the second drive motor 95 is transmitted to each pump section 32 of the second supply unit 3B.

In the present embodiment, the first drive shaft 92 rotates as a result of a driving force transmitted from the first drive motor 94. The second drive shaft 93 rotates as a result of a driving force transmitted from the second drive motor 95. That is, the first drive shaft 92 and the second drive shaft 93 rotate independently of each other. Therefore, the first drive shaft 92 and the second drive shaft 93 can transmit a drive force to the camshaft 91X independently of each other. As a result, the pump sections 32 of the first supply unit 3A can be driven independently of the pump sections 32 of the second supply unit 3B and vice versa.

Next, a configuration of a vicinity of the maintenance area M in the present embodiment will be described with reference to FIG. 7.

As shown in FIG. 7, the inkjet recording apparatus 1 further includes an ink tank shelf 109, a capping mechanism 7, and a cleaning mechanism 8. The ink tank shelf 109 is disposed at an upper part of the maintenance area M. The ink tank IT is disposed on the ink tank shelf 109.

The maintenance area M has a first region R1 and a second region R2 different from the first region R1. Specifically, the second region R2 is located closer to the image forming area P than the first region R1 (located on the left of the first region R1). The capping mechanism 7 is disposed in the second region R2. The cleaning mechanism 8 is disposed in the first region R1.

The cleaning mechanism 8 cleans the ink discharge surface 22 of the recording head 21 after a purge operation. The capping mechanism 7 caps the ink discharge surface 22 of the recording head 21 after cleaning. As a result, drying of the ink is inhibited, and occurrence of ink clogging is inhibited.

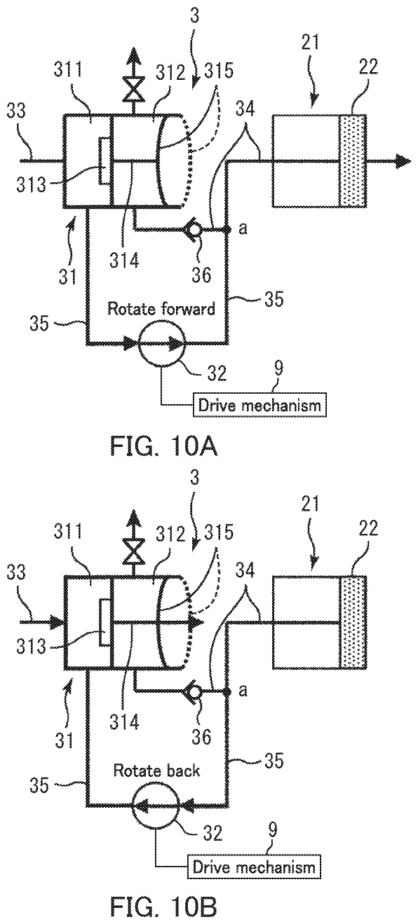

Next, the recording head 21 and the ink supply mechanism 3 in the present embodiment will be further described with reference to FIGS. 9, 10A, and 10B. First, a configuration of the recording head 21 and the ink supply mechanism 3 will be described with reference to FIG. 9. FIG. 9 is a diagram illustrating a configuration of the recording head 21 and the ink supply mechanism 3.

The ink supply mechanism 3 is located between the ink tank IT and the recording head 21.

The ink tank IT is disposed on the ink tank shelf 109 as already described with reference to FIG. 7. The ink supply mechanism 3 is disposed above the recording head 21. The ink tank shelf 109 is disposed above the ink supply mechanism 3. Therefore, the ink tank IT is disposed above the recording head 21 and the ink supply mechanism 3. Specifically, the ink tank IT is disposed at a location higher than the ink discharge surface 22 by a height h. The height h is a hydraulic head difference. The ink in the ink tank IT is supplied to the ink supply mechanism 3 due to the hydraulic head difference.

The tank section 31 of the ink supply mechanism 3 has a first chamber 311 and a second chamber 312.

The first chamber 311 temporarily stores ink under a positive pressure. To the first chamber 311, no negative pressure is exerted, and a pressure due to the hydraulic head difference is exerted in addition to atmospheric pressure. The first chamber 311 communicates with the ink tank IT via the upstream pipe 33.

The second chamber 312 temporarily stores ink under a negative pressure. The second chamber 312 is disposed downstream of the first chamber 311 in an ink flow channel The second chamber 312 is under a negative pressure. The second chamber 312 communicates with the recording head 21 (ink discharge surface 22) via the downstream pipe 34.

The first chamber 311 and the second chamber 312 are separated by a wall. An on-off valve 313 is disposed on the wall. The on-off valve 313 transitions between two states, an open state and a closed state. The open state is a state in which the on-off valve 313 is open. In the open state, ink can flow from the first chamber 311 to the second chamber 312. The closed state is a state in which the on-off valve 313 is closed. In the closed state, the ink flow from the first chamber 311 to the second chamber 312 is stopped.

The on-off valve 313 is coupled to a pressing member 314. As a result of a force exerted on the pressing member 314, the on-off valve 313 transitions from the closed state to the open state. Conversely, as a result of release of the force exerted on the pressing member 314, the on-off valve 313 transitions from the open state to the closed state.

The second chamber 312 includes an atmospheric pressure detection film 315 as a part thereof. The atmospheric pressure detection film 315 is a flexible film. Therefore, when the negative pressure in the second chamber 312 exceeds a specific threshold, the atmospheric pressure detection film 315 deforms. As a result of the atmospheric pressure detection film 315 deforming, a deformation force due to the deformation is exerted on the pressing member 314. As a result, the on-off valve 313 transitions to the open state.

The ink is supplied from the ink tank IT to the recording head 21 via two paths of the ink supply mechanism 3. One path passes through the upstream pipe 33, the first chamber 311, the second chamber 312, and the downstream pipe 34. The path does not include the pump section 32 in the middle thereof. The other path passes through the bypass pipe 35 instead of the second chamber 312. Specifically, the other path passes through the upstream pipe 33, the first chamber 311, the bypass pipe 35, and the downstream pipe 34. The pump section 32 is disposed in the middle of the bypass pipe 35. The path does not pass through the second chamber 312.

Next, operation of the ink supply mechanism 3 in the present embodiment will be described with reference to FIGS. 9, 10A, and 10B. FIG. 9 illustrates a state of the recording head 21 and the ink supply mechanism 3 in an image forming mode.

The ink supply mechanism 3 has three modes, and operates while transitioning between modes. Specifically, the ink supply mechanism 3 has an image forming mode, a positive pressure mode, and a negative pressure mode. Specifically, the ink supply mechanism 3 transitions between the image forming mode, the positive pressure mode, and the negative pressure mode.

In the image forming mode, the recording head 21 forms an image on the cloth W.

Until the image forming mode starts, the ink supply mechanism 3 is in the negative pressure mode. Therefore, the second chamber 312 is under a specific negative pressure. As a result, a negative pressure is exerted also on the downstream pipe 34 and the ink discharge surface 22. Until the image forming mode starts, the on-off valve 313 is in the closed state.

As illustrated in FIG. 9, in the image forming mode, a specific amount of ink is charged in the first chamber 311 and the second chamber 312. The pump section 32 is at rest. The ink flows into the recording head 21 from the second chamber 312 via the downstream pipe 34. The second chamber 312 is isolated from the atmosphere. Therefore, as the amount of ink in the second chamber 312 decreases, the negative pressure in the second chamber 312 increases.

As a result of the negative pressure in the second chamber 312 exceeding a specific threshold, the atmospheric pressure detection film 315 deforms due to atmospheric pressure. As a result of the atmospheric pressure detection film 315 deforming, a deformation force due to the deformation is exerted on the pressing member 314. As a result of the deformation force exerted on the pressing member 314, the on-off valve 313 transitions from the closed state to the open state. As a result of the on-off valve 313 transitioning from the closed state to the open state, the ink flows from the first chamber 311 to the second chamber 312.

As a result of the ink flowing into the second chamber 312, the pressure in the second chamber 312 gradually comes close to the atmospheric pressure. Along with this, the deformation of the atmospheric pressure detection film 315 also gradually decreases. As a result of the deformation of the atmospheric pressure detection film 315 decreasing, the deformation force exerted on the pressing member 314 also gradually decreases. When the negative pressure in the second chamber 312 comes equal to or lower than the specific threshold, the on-off valve 313 transitions to the closed state. As a result of the on-off valve 313 transitioning from the open state to the closed state, the ink flow from the first chamber 311 to the second chamber 312 stops.

The ink is replenished from the ink tank IT to the first chamber 311 in an amount corresponding to the amount having flowed from the first chamber 311 to the second chamber 312. In the image forming mode, the operation as above is repeated.

FIG. 10A is a diagram illustrating a state of the recording head 21 and the ink supply mechanism 3 in the positive pressure mode. In the positive pressure mode, a positive pressure is exerted on the ink. As a result, a purge operation is performed, and the ink discharge surface 22 is cleaned.

In the positive pressure mode, the pump section 32 is driven to rotate forward by the drive mechanism 9. As a result of the pump section 32 driven to rotate forward, the ink is diverted from the second chamber 312. In other words, the ink flows through the upstream pipe 33, the first chamber 311, and the bypass pipe 35 toward the downstream pipe 34. In other words, the ink pressurized by the pump section 32 is supplied to the recording head 21 and thereafter discharged from the ink discharge surface 22. That is, a purge operation is performed, and the ink discharge surface 22 is cleaned.

Note that the pressurized ink in the positive pressure mode may flow backward through the downstream pipe 34 into the second chamber 312 to damage the atmospheric pressure detection film 315. In order to prevent the backflow of the ink, the ink supply mechanism 3 includes a backflow prevention mechanism 36. The backflow prevention mechanism 36 is disposed in the downstream pipe 34. Specifically, the backflow prevention mechanism 36 is disposed upstream of a junction “a” of the downstream pipe 34 and a downstream end of the bypass pipe 35. As a result, the backflow prevention mechanism 36 closes the upstream side of the junction a of the downstream pipe 34, and all the ink pressurized by the pump section 32 flows to the ink discharge surface 22. In this manner, damage to the atmospheric pressure detection film 315 is prevented.

FIG. 10B is a diagram illustrating a state of the recording head 21 and the ink supply mechanism 3 in the negative pressure mode. In the negative pressure mode, a negative pressure is exerted on the ink. As a result, the ink is inhibited from leaking down from the ink discharge surface 22.

In the negative pressure mode, the pump section 32 is driven to rotate back by the drive mechanism 9. As a result of the pump section 32 driven to rotate back, a specific negative pressure is exerted on the ink discharge surface 22 and the second chamber 312 via the downstream pipe 34 and the bypass pipe 35. Specifically, the specific negative pressure is a negative pressure at which the ink does not leak down from the ink discharge surface 22 even when the ink is supplied using the hydraulic head difference. More specifically, the specific negative pressure is a weak negative pressure of about −0.2 to −0.7 kPa. Further, as described in the description of the image forming mode, under the specific negative pressure applied in the negative pressure mode, the on-off valve 313 is not opened but kept closed.

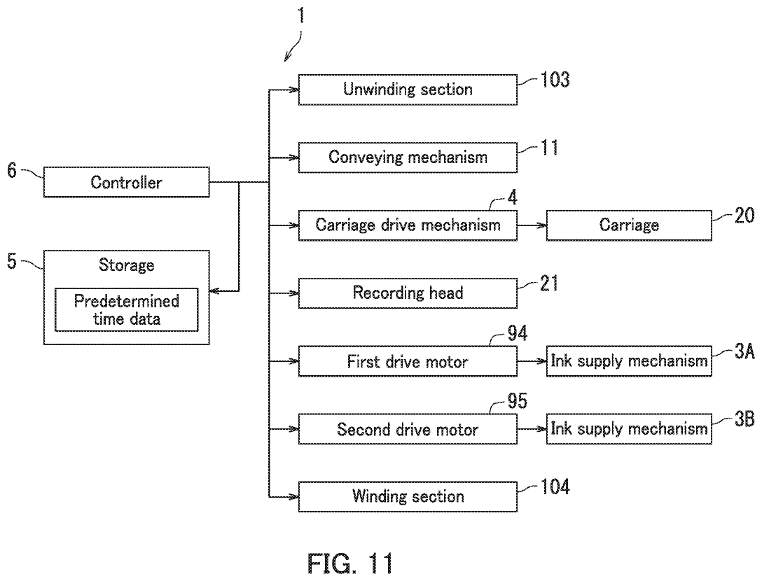

Next, a configuration of the inkjet recording apparatus 1 in the present embodiment will be described with reference to FIG. 11. FIG. 11 is a block diagram illustrating the configuration of the inkjet recording apparatus 1.

The inkjet recording apparatus 1 further includes storage 5 and a controller 6. The storage 5 stores a control program and various information such as setting information. The storage 5 includes a storage device and semiconductor memory. The storage device includes for example either or both of a hard disk drive (HDD) and a solid state drive (SSD). Examples of the semiconductor memory include random access memory (RAM) and read only memory (ROM).

As illustrated in FIG. 11, the storage 5 stores predetermined time data. The predetermined time data represents time required before completion of purge (predetermined time) in the positive pressure mode. The predetermined time is for example 5 seconds. The predetermined time data is factory-set in the storage 5 according to the type of the recording head 21 and the type of ink. The predetermined time data may be reset by a service person or a user.

The controller 6 controls the operation of each section of the inkjet recording apparatus 1 by executing the control program. The controller 6 includes a processor such as a central processing unit (CPU). The controller 6 further includes an integrated circuit for image forming processing. The integrated circuit for image forming processing includes for example an application specific integrated circuit (ASIC).

The controller 6 controls operation of the carriage drive mechanism 4. Specifically, the controller 6 controls the carriage drive mechanism 4 so that the carriage 20 moves in the left-right directions shown in FIGS. 1 to 7. Therefore, the carriage 20 can move between the first region R1 and the second region R2 to be located in the first region R1.

The controller 6 controls the rotation direction and the rotational speed of the first drive motor 94. The controller 6 also controls the rotation direction and the rotational speed of the second drive motor 95. According to the rotation direction and the rotational speed of the first drive motor 94 and the second drive motor 95, the rotation direction and the rotational speed of the pump section 32 (the eccentric cam of the tubing pump) change. As a result of the rotation direction and the rotational speed of the eccentric cam changing, the direction and the magnitude of the pressure exerted on the ink also change. In other words, the controller 6 can control whether a positive pressure is exerted on the ink or a negative pressure is exerted on the ink. Specifically, the controller 6 can control the ink supply mechanism 3 so that a positive pressure is exerted on the ink. As a result of a positive pressure exerted on the ink, the recording head 21 performs a purge operation.

The controller 6 measures the time from the start of purge. The controller 6 compares the measured time with the predetermined time stored in the storage 5. The controller 6 controls the first drive motor 94 and the second drive motor 95 to rotate back after the measured time reaches the predetermined time. As a result of the first drive motor 94 and the second drive motor 95 rotating back, the ink supply mechanism 3 exerts a negative pressure on the ink.

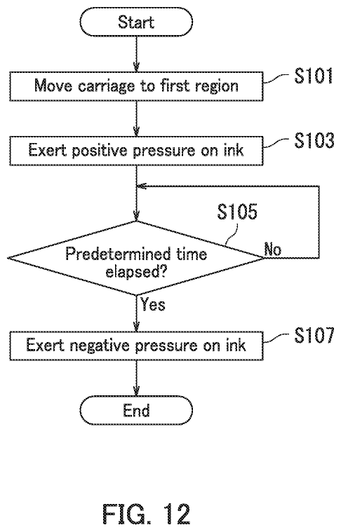

Subsequently, a process executed by the controller 6 in the present embodiment will be described with reference to FIG. 12. FIG. 12 is a flowchart illustrating a process executed by the controller 6 in the present embodiment. The process illustrated in FIG. 12 is executed for example every time the image forming mode ends. The process shown in FIG. 12 (processes shown in steps S101, S103, S105, and S107) is an example of the cleaning operation of the present invention.

In step S101, the controller 6 controls the carriage drive mechanism 4 so that the carriage 20 moves to the first region R1. In other words, the controller 6 controls the operation of the carriage drive mechanism 4 so that the recording head 21 is located in the first region R1. The process proceeds to step S103.

In step S103, the controller 6 controls the first drive motor 94 and the second drive motor 95 so as to cause the first drive motor 94 and the second drive motor 95 to rotate forward. As a result of the first drive motor 94 and the second drive motor 95 rotating forward, the pump section 32 of the ink supply mechanism 3 rotates forward. As a result, a positive pressure is exerted on the ink, and a purge operation starts. The process proceeds to step S105.

In step S105, the controller 6 determines whether or not a predetermined time has elapsed since the start of the purge operation. When the controller 6 determines that the predetermined time has elapsed since the start of the purge operation (Yes in step S105), the process proceeds to step S107. That is, the operation in which the pump section 32 exerts a positive pressure on the ink (purge operation) ends when the operation has been performed for the predetermined time. When the controller 6 determines that the predetermined time has not elapsed since the start of the purge operation (No in step S105), the process repeats step S105 until the predetermined time has elapsed.

In step S107, the controller 6 controls the first drive motor 94 and the second drive motor 95 so as to rotate back. As a result of the first drive motor 94 and the second drive motor 95 rotating back, the pump section 32 of the ink supply mechanism 3 rotates back. As a result, a negative pressure is exerted on the ink, and the operation shown in FIG. 12 is completed.

The embodiment has been described so far. In the present embodiment, the purge operation is performed in the first region R1 but the capping mechanism 7 is disposed in the second region R2. Therefore, contamination of the cap of the capping mechanism 7 by the purge operation is inhibited. As a result, user convenience can be improved. In addition, in the present embodiment, the ink supply mechanism 3 exerts a negative pressure on the ink after the purge operation is completed. That is, after completion of the purge operation, an operation in which the pump section 32 exerts a negative pressure on the ink (follow operation) is performed. Accordingly, even though the ink supply mechanisms 3 is disposed above the ink discharge surface 22, the ink in the downstream pipe 34 is lowered, thereby inhibited from leaking down from the ink discharge surface 22. As a result, user convenience can be improved. Further, as a result of the ink tank IT being disposed above the ink supply mechanism 3, the ink in the downstream pipe 34 is likely to be lowered but inhibited from leaking down from the ink discharge surface 22 by the follow operation.

Further, in the present embodiment, positive pressure exertion and negative pressure exertion on the ink can be achieved by one pump. Therefore, the configuration of the apparatus can be simplified.

The present embodiment has been described so far with reference to drawings. However, the present disclosure is not limited to the above embodiment and may be implemented in various different forms that do not deviate from the essence of the present disclosure (for example, (1) to (6) described below). The drawings schematically illustrate elements of configuration in order to facilitate understanding, and numbers or the like of elements of configuration illustrated in the drawings may differ from actual properties thereof in order to facilitate preparation of the drawings. Further, the shape of each element or the like described in the above embodiment is merely an example that does not impose any particular limitations and may be altered in various ways as long as such alterations do not substantially deviate from the effects of the present disclosure.

(1) In the present embodiment, the inkjet recording apparatus 1 is a textile printing apparatus in which an ink tank IT is disposed at an upper part of the recording head 21. However, the present disclosure is not limited thereto. For example, the inkjet recording apparatus according to the present disclosure may be an industrial inkjet recording apparatus in which an ink tank IT is disposed at a lower part the recording head 21.

(2) In the present embodiment, the recording medium is a cloth W, but the present disclosure is not limited thereto. The material of the recording medium may be for example paper. An image formed on a long recording medium (paper) can be transferred to a long cloth W.

(3) In the present embodiment, the configuration in which the number of recording heads 21 is two has been described, but the number of recording heads 21 is not limited to two. The number of recording heads 21 may be more than two, or one.

(4) In the present embodiment, the configuration in which four ink supply mechanisms 3 are connected to one recording head 21 has been described, but the present disclosure is not limited thereto. The number of ink supply mechanisms 3 connected to one recording head 21 may be more than four, or less than four.

(5) In the present embodiment, the inkjet recording apparatus 1 has a tubing pump, but the present disclosure is not limited thereto. The inkjet recording apparatus 1 can use any pump without any particular limitation as long as positive pressure exertion and negative pressure exertion on the ink can be achieved by the pump.

(6) In the present embodiment, the inkjet recording apparatus 1 includes the first drive motor 94 and the second drive motor 95, but the present disclosure is not limited thereto. The inkjet recording apparatus 1 may include only one drive motor, or three or more drive motors for driving the pump section 32.

What is claimed is:

1. An inkjet recording apparatus comprising:
a recording head having an ink discharge surface and configured to discharge an ink from the ink discharge surface onto a recording medium;
an ink supply mechanism configured to supply the ink to the recording head;
a motor rotatable back and forth; and
a controller, wherein
the ink supply mechanism includes a pump,
the pump exerts a positive pressure or a negative pressure on the ink according to a rotation direction of the motor,
the controller controls the motor so as to perform a cleaning operation for cleaning the ink discharge surface, and
the cleaning operation includes
a purge operation in which the pump exerts a positive pressure on the ink, and
a follow operation in which the pump exerts a negative pressure on the ink after completion of the purge operation.

2. The inkjet recording apparatus according to claim 1, further comprising
a carriage that mounts thereon the recording head and the ink supply mechanism disposed above the ink discharge surface.

3. The inkjet recording apparatus according to claim 2, further comprising
a cleaning mechanism configured to clean the ink discharge surface; and
a capping mechanism configured to cap the ink discharge surface, wherein
the carriage moves between a first region and a second region different from the first region,
the cleaning mechanism is disposed in the first region,
the capping mechanism is disposed in the second region, and
the controller performs the cleaning operation in a state where the carriage is located in the first region and thereafter performs capping in a state where the carriage is moved to the second region.

4. The inkjet recording apparatus according to claim 2, further comprising
an ink tank configured to store the ink supplied to the recording head by the ink supply mechanism, wherein
the ink tank is disposed above the ink supply mechanism.

5. The inkjet recording apparatus according to claim 1, wherein
the ink supply mechanism further includes a second chamber,
the ink supply mechanism includes at least two paths for allowing the ink passing therethrough, of which a path includes the pump and does not pass through the second chamber, and a different path passes through the second chamber, and
when a negative pressure greater than a specific threshold is exerted on the second chamber, the ink passes through the second chamber and the ink supply mechanism supplies the ink having passed through the second chamber to the recording head, and when a negative pressure equal to or less than the specific threshold is exerted on the second chamber, the ink does not pass through the second chamber and the ink supply mechanism does not supply the ink having passed through the second chamber to the recording head.

6. The inkjet recording apparatus according to claim 5, wherein
the negative pressure exerted on the ink by the pump in the follow operation is a negative pressure equal to or lower than the specific threshold.

7. The inkjet recording apparatus according to claim 1, wherein
the pump is a tubing pump.
